(19) United States
(12) Patent Application Publication
(10) Pub. No.: US 2006/0236815 A1
(43) Pub. Date: Oct. 26, 2006

(54) INSTALLATION TOOL FOR SETTING SELF-DRILLING SHEAR FASTENERS

(76) Inventors: Peter M. Beecherl, Algonac, MI (US); Patrick Monahan, Rockton, IL (US); Jonathan Huffman, Machesney Park, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/380,042

(22) Filed: Apr. 25, 2006

Related U.S. Application Data
(60) Provisional application No. 60/674,908, filed on Apr. 26, 2005.

(51) Int. Cl. B25B 13/00; B25B 21/00

(52) U.S. Cl. 81/54

(57) ABSTRACT

A fastener installation tool which includes an axial assist mechanism as well as adjustable feet and a simple drive position limiter. The installation tool is connectable to the chuck of a standard drill. During use, the feet are stepped upon, causing the housing to move along the drive shaft, generally toward the fastener, causing the feet to contact the workpiece. Then, the drill is actuated, causing the drive shaft to rotate and the fastener to thread into the workpiece. At some point during fastener installation, further axial motion of the tool stops as the fastener continues to travel axially due to threading action, and reduces its head engagement with the drive socket. As the fastener seats on the workpiece, the drive socket disengages from the head of the fastener.

### RELATED APPLICATION (PRIORITY CLAIM)

This application claims the benefit of U.S. Provisional Application Ser. No. 60/674,908, filed Apr. 26, 2005, which is hereby incorporated herein by reference in its entirety.

### BACKGROUND

The present invention generally relates to installation tools for setting fasteners, and more specifically relates to an installation tool for setting self-drilling shear fasteners.

Typically (and definitely with regard to self-drilling, self-tapping fasteners), when an operator uses a drive tool, such as a drill, to drive a fastener into a work piece, the operator must use his upper body strength to apply an axial force to the drive tool. It is advantageous to reduce the amount of upper body strength an operator must apply to a drive tool to effect the installation of a fastener because doing so reduces the fatigue and physical stress experienced by the operator. This is especially true because oftentimes a large number of fasteners must be installed to complete a job.

Some drive tools are configured such that, if an operator wishes to use the drive tool to install a fastener into a floor, the operator must get on the floor, on his knees, in order to use the drive tool to drive the fastener into the floor. Of course, getting on one's knees every time one installs a fastener in a floor can be uncomfortable and tedious. This is especially true in the case where a large number of fasteners must be installed over a large floor surface area.

Other drive tools, such as those which are disclosed in U.S. Pat. Nos. 3,960,191; 4,236,555; and 5,897,045, are configured such that an operator can remain standing while using the drive tool to install fasteners into a floor. Such drive tools are essentially extended tools connected to a power drill or to some other driving source. Typically, the drive tool is configured such that fasteners are automatically fed to the end of the drive tool. This provides that the operator can use the drive tool to install a plurality of fasteners without having to bend over each time to place a fastener at the end of the tool. Unfortunately, such drive tools are typically relatively heavy and the operator must apply substantial upper body effort to apply the necessary axial force to the drive tool to install a fastener. Therefore, using such a drive tool, especially if an operator must use the drive tool everyday for extended periods of time, can be tiring.

In some cases, the type of job to be preformed using such a drive tool increases the resulting fatigue experienced by the operator. For example, U.S. Pat. No. 5,605,423 discloses the installation of fasteners in a composite deck system. Such a composite deck system is used in building construction, and provides that a corrugated deck is placed over structural supports, and fasteners are driven into the composite deck material to fasten it to the structural supports. Because the deck is corrugated, the operator must lift the drive tool over each upward standing corrugation portion to drive a course of fasteners into the underlying structural supports. This process requires repetitive bending and shifting of weight over the drive tool, and this can be tiring. As might be expected, such repetitive action can cause competitive motion problems for the operator.

U.S. Pat. Nos. 6,296,064; 6,585,141; and 6,622,596 disclose fastener drive tools which are configured such that an operator can remain standing while using the drive tool to install fasteners into a floor. Each of the drive tools which are disclosed in these patents includes an internal axial load assist mechanism which reduces the amount of upper body effort an operator must apply to install a fastener. Furthermore, the tools include a foot pad which may be stepped upon by the operator during fastener installation, to effect actuation of the axial load assist mechanism.

Presently, to install self-drilling shear fasteners (such as Textron's Shearflex® brand fasteners), one of two methods are used. The first commonly-used method is to use a conventional fastener setting tool, such as an impact wrench. The disadvantages of using a conventional fastener setting tool include the fact that it is time-consuming as well as the fact that, in use, they are very demanding on the operator. Self-drilling shear fasteners require that approximately 100 lbf be applied to the fastener drill point in order for the drilling process to be effective. Conventional tooling requires the operator to manually apply this force with pure body strength.

The second-commonly-used method is to use an installation tool such as is disclosed in U.S. Pat. Nos. 6,296,064; 6,585,141; and 6,622,596, wherein the installation tool includes an axial load assist mechanism. While the installation tools disclosed in U.S. Pat. Nos. 6,296,064; 6,585,141; and 6,622,596 are beneficial, these tools are relatively complex, include many components, and are expensive. To further exasperate the problem, these types of tools are often lost or damaged at a work site, resulting in the need to purchase another installation tool.

### OBJECTS AND SUMMARY

An object of an embodiment of the present invention is to provide a simplified fastener installation tool, such as a tool for installing self-drilling shear fasteners.

Another object of an embodiment of the present invention is to reduce the installation time of self-drilling shear fasteners as well as provide a tool which is simplified and less expensive compared to, for example, the tools which are disclosed in U.S. Pat. Nos. 6,296,064; 6,585,141; and 6,622,596.

Briefly, a specific embodiment of the present invention provides a fastener installation tool which is engageable with a drive tool, such as a conventional drill at one end, and a fastener at the other end. The tool includes an axial assist mechanism as well as feet which are stepped upon during the fastener installation process. The tool also effectively includes a simple drive position limiter.

Specifically, the tool includes a spring which is disposed generally in a housing about a drive shaft. Initially, a fastener, such as a self-drilling shear fastener, is disposed in the end of the tool and brought into contact with the workpiece. Subsequently, the feet of the tool are stepped upon, causing the housing to move along the drive shaft, generally toward the fastener, and causing the feet to move downward and contact the workpiece. Then, the drive tool is actuated causing the drive shaft to rotate and the fastener to thread into the workpiece. Preferably, the tool has been appropriately pre-adjusted such that when a flange of the fastener is located approximately the fastener head thickness above the workpiece, axial motion of the tool stops due to a split ring on the drive shaft contacting a top of the housing. The fastener continues to travel axially due to the threading action into the workpiece and reduces its head engagement with the drive socket. As the fastener seats on the workpiece, the drive socket disengages from the head of the fastener due to the high torque transmission with minimal head engagement.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 provides a side view of an installation tool which is in accordance with an embodiment of the present invention, showing the installation tool engaged with a drive tool, showing feet of the installation tool pressed down to a workpiece, and showing a fastener installed;

FIG. 2 provides a cross-sectional view of a bottom portion of the installation tool shown in FIG. 1, showing the fastener prepared for installation and showing feet of the tool unloaded;

FIG. 3 is similar to FIG. 2, but shows the tool after the feet have been loaded (i.e., stepped down upon); and

FIG. 4 is similar to FIG. 3, but shows the fastener installed.

### DESCRIPTION

While the present invention may be susceptible to embodiment in different forms, there is shown in the drawings, and herein will be described in detail, a specific embodiment thereof with the understanding that the present description is to be considered an exemplification of the principles of the invention and is not intended to limit the invention to that as illustrated and described herein.

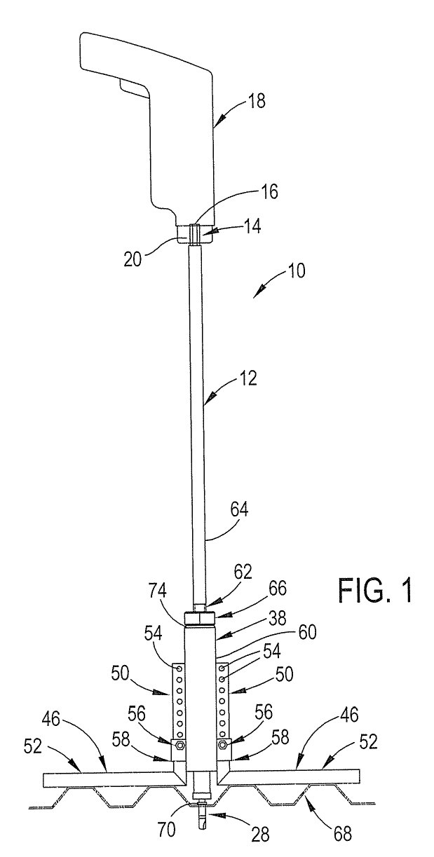

Shown in FIG. 1 is a fastener installation tool 10 which is in accordance with an embodiment of the present invention. The tool 10 is relatively simple, includes few components, and is relatively inexpensive to manufacture. The tool 10 is simplified and less expensive compared to, for example, the tools which are disclosed in U.S. Pat. Nos. 6,296,064; 6,585,141; and 6,622,596. The tool 10 can be used to reduce the installation time of self-drilling shear fasteners, such as Textron's Shearflex® Fasteners, for applications such as securing concrete flooring to steel decking material.

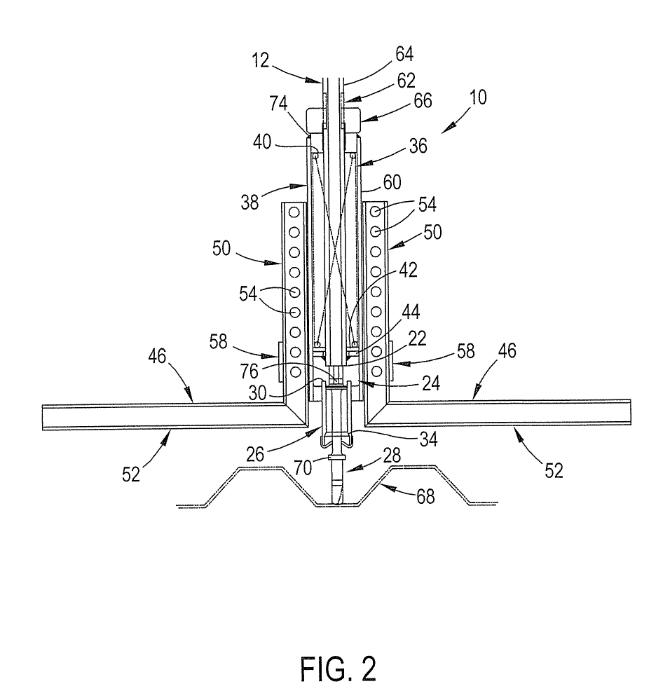

As shown in FIG. 1, the tool 10 includes a drive shaft 12 which has a drive adapter 14 at one end 16 for engagement with a drive tool 18, such as the chuck 20 of a conventional drill. Specifically, preferably the drive adapter 14 has a hex profile for engagement with the drill chuck 20. As shown in FIGS. 2-4, another end 22 of the drive shaft 12 is engaged with a drive socket 24 which is configured to retain a guide tube 26 and engage a fastener 28, such as a self-drilling shear fastener, during installation. Specifically, preferably the drive socket 24 is configured to receive an end 30 of the guide tube 26 in a press fit arrangement, and an opposite end 32 of the guide tube 26 has a fastener retainer 34 thereon for holding a fastener 28 in the drive socket 24, specifically while an operator is positioning the tool 10 to install a fastener 28.

A spring 36 is disposed about a portion of the drive shaft 12 and is generally retained in a housing 38 which is generally tubular. The spring 36 is generally disposed between an internal wall 40 of the housing 38 and a washer 42, preferably hardened, which is disposed in the housing 38. A thrust bearing 44 is disposed between the drive socket 24 and the washer 42. As will be discussed more fully hereinbelow, the spring 36 is configured to function as an axial load assist mechanism during fastener installation.

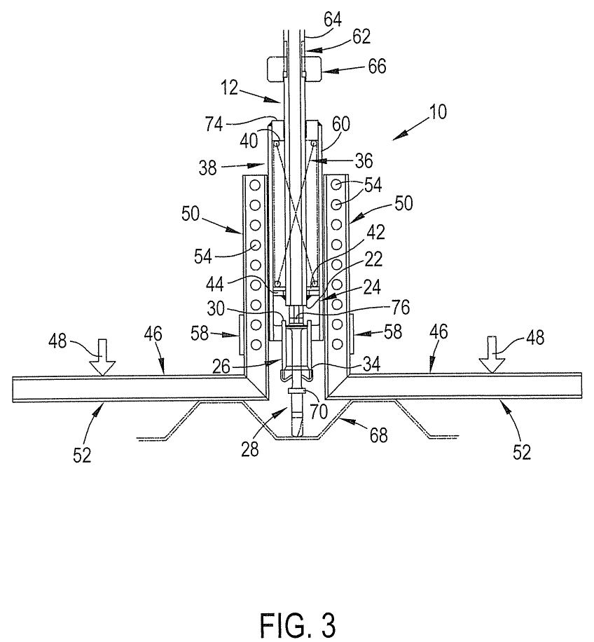

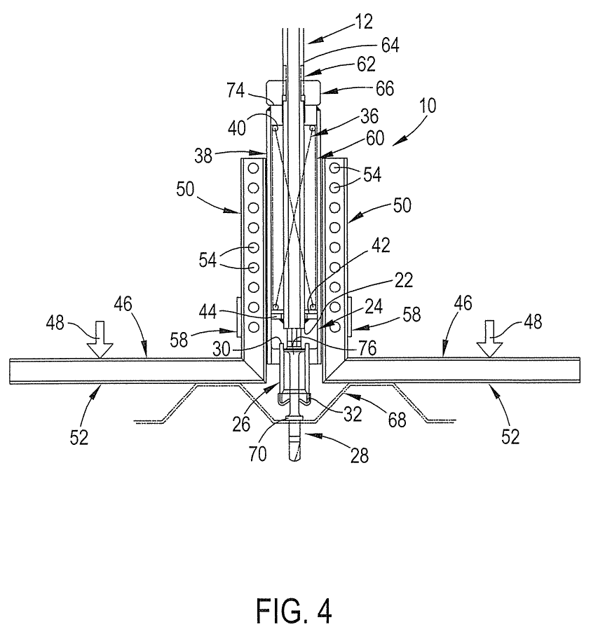

The installation tool 10 preferably includes adjustable feet 46 which are configured to be stepped upon by the operator (represented in FIGS. 3 and 4 with arrows 48) during fastener installation. Preferably, the feet 46 are generally L-shaped, having a vertical arm 50 and a horizontal leg 52. Preferably, the vertical arm 50 includes through holes 54 which receive pins 56 which secure the feet 46 in place relative to the housing 38. Specifically, preferably the housing 38 includes tubes 58 which are provided (such as welded) generally 180 degrees apart about the outer surface 60 of the housing 38. The tubes 58 are configured to receive the vertical arms 50, and the pins 56 extend into the tubes 58 for engaging the holes 54 which are on the arms 50, thereby securing the adjustable feet 46 relative to the housing 38. The tubes 58 function to retain the adjustable feet 46, as well as to guide the feet 46 during adjustment.

Preferably, a portion of the drive shaft 12 is externally threaded, thereby providing a threaded portion 62 on its external surface 64. A split ring 66, which is internally threaded, is clamped onto the threaded portion 62 of the drive shaft 12. The position of the split ring 66 on the drive shaft 12 is adjustable merely by unclamping, repositioning, and re-clamping the split ring 66 on the threaded portion 62 of the drive shaft 12. The position of the split ring 66 relative to the drive shaft 12 is important because, as will be described more fully hereinbelow, this controls the axial stop position of the tool 10. As shown in FIG. 1, the drive shaft 12 is generally exposed in an area between the drill 18 and the split ring 66, thereby simplifying the overall design. The housing 60 encloses only a portion of the drive shaft 12 at any one time during operation of the tool 10.

Preferably, in addition to the adjustability of the feet 46 and the split ring 66, a plurality of different-sized guide tubes 26 are provided, and the operator can elect which guide tube to install in the drive socket 24, depending on which size fastener is going to be installed using the tool 10.

The installation tool 10 is assembled by engaging the drive shaft 12 with the drive socket 24 and then sliding the thrust bearing 44 and then the washer 42 down the drive shaft 12 until they contact the drive socket 24. The spring 36 is then slid down the drive shaft 12 until it contacts the washer 42. Then, the housing 38 is slid down the drive shaft 12 until its internal wall 40 contacts the spring 36. Preferably, load is applied to the housing 38 to slightly preload the spring 36. Next, the split ring 66 is clamped on the drive shaft 12 to retain the housing 38 and spring 36 preload. Preferably, the split ring 66 is clamped on the drive shaft 12 at a position which provides a desired axial stop position of the tool 10 during operation.

To operate the installation tool 10, an operator determines what size fastener is going to be installed using the tool 10, adjusts the feet 46 to the appropriate position (and secures the pins 56), and fine tunes the position of the split ring 66. The position of the split ring 66 is critical because this controls the axial stop position of the tool 10, as will be described in more detail hereinbelow. The operator also selects and installs the appropriate guide tube 26 by pressing the end 30 of the guide tube 26 into the drive socket 24.

Next, the operator connects the installation tool 10 to a drive tool 18. Specifically, the operator may, for example, engage the drive adapter 14 to the chuck 20 of a conventional drill 18. Once the installation tool 10 is engaged with the drive tool 18, the tool 10 is ready for use for installing fasteners. The operator inserts a fastener 28, such as a self-drilling shear fastener, through the fastener retainer 34 (on the end 32 of the guide tube 26) and into the drive socket 24. The fastener retainer 34 works to hold the fastener 28 in the drive socket 24 while the operator positions the tool 10 for fastener installation. The operator then positions tool 10 relative to the workpiece 68 such that the fastener 28 contacts the workpiece 68, as shown in FIG. 2, places his feet on the two adjustable feet 46 of the tool 10, and applies downward pressure (represented in FIGS. 3 and 4 using arrows 48) until the adjustable feet 46 contact the workpiece 68, as shown in FIG. 3. As the downward pressure is applied, the adjustable feet 46 and housing 38 move together, away from the split ring 66 that is clamped to the drive shaft 12. The spring 36 in the housing 38 is compressed, which in turn transfers the spring force to the drive socket 24 and fastener 28. Preferably, the feet 46 are positioned such that the final force applied to the fastener 28 is approximately 100 lbf, which is required to maximize the efficiency of the self-drilling function of the fastener.

The operator then activates the drive tool 18 (i.e., the motor of the drill) to generate the torque required to set the fastener 28. The torque from the drill motor is transmitted through the drive shaft 12 and drive socket 24 to the fastener 28. As the drive shaft 12 rotates, the thrust bearing 44 allows for relative motion between the washer 42 and the drive socket 24. Therefore, the washer 42, spring 36, and housing 38 remain stationary throughout the process.

Preferably, the split ring 66 is positioned such that when the fastener flange 70 is located proximate the fastener head height above the workpiece 68, the axial motion of the drive shaft 12 stops due to the split ring 66 contacting the topside 74 of the housing 38. The fastener 28 continues to travel axially due to its threading action (i.e., into the workpiece 68). As the fastener flange 70 seats against the workpiece 68, the drive socket 24 disengages from the head 76 of the fastener 28, as shown in FIGS. 1 and 4 (i.e., the drive socket 24 simply slips off the head 76 of the fastener 28 due to the high torque being transmitted through a very limited hex engagement). At this point, the operator can repeat the process by inserting another fastener in the fastener retainer 34 and performing the subsequent steps.

The major differences between the design of the installation tool shown in FIGS. 1-4 and those which are disclosed in, for example, U.S. Pat. Nos. 6,585,141 and 6,622,596, are summarized in the following table:

| | The tool shown in the | |
|---|---|---|
| | ‘141 and ‘596 patents | The present tool |
| | (“the old design”) | (“the new design”) |
| Number of components | 51 | 13 |
| Torque limiter | Inline slip clutch | Drive position limiter |
| Drive device | Drill motor w/ | Standard drill motor |
| | modified chuck | |
| Fastener adjustability | Multiple spacers | Adjustable feet |
| Tool Weight | High | Low (especially |
| | | if formed |
| | | of aluminum) |
| Cost | High | Low |

The major advantages of the new design over the old design are as follows:

1. The new design has greatly reduced the overall complexity of the design, which reduces cost and should increase the overall reliability.

2. The new design uses a simple drive position limiter (as described hereinabove) to control when the tool stops applying torque to the fastener versus a conventional slip clutch design.

3. The new design does not require the drill motor's standard chuck to be removed from the drill in order to connect the drill to the installation tool. As described hereinabove, the present installation tool 10 is configured to connect directly to the chuck 20 of a standard drill 18, without any modifications.

4. The new design has adjustable feet 46 that retain their position via removable pins 56. Therefore, the feet can be quickly and easily adjusted for various fastener lengths (if the fastener length is going to be varied, the shortest guide tube 26 can be used). In contrast, some other designs require that the end of the tool be disassembled and a spacer combination varied to meet the fastener requirement.

5. The new design is lower in cost and weight when compared to the old design, primarily due to the number of components in the design.

As such, an embodiment of the present invention provides a fastener installation tool which is relatively simple, includes few components, and is relatively inexpensive to manufacture. The tool is simplified and less expensive compared to, for example, the tools which are disclosed in U.S. Pat. Nos. 6,296,064; 6,585,141; and 6,622,596. The tool can be used to reduce the installation time of, for example, self-drilling shear fasteners, such as Textron's Shearflex® Fasteners.

While an embodiment of the present invention is shown and described, it is envisioned that those skilled in the art may devise various modifications of the present invention without departing from the spirit and scope of the disclosure.

What is claimed is:

1. A tool for operation with a drill for installing a fastener, said tool having a first end configured to engage with the drill and a second end configured to engage the fastener, said tool comprising: a housing; a spring in the housing; a drive shaft which extends into the housing, through the spring, and is configured to rotate upon operation of the drill; an axial drive limiting member on the drive shaft and contactable with the housing; and feet which are engaged with the housing such that stepping on the feet during use of the tool causes the spring in the housing to compress, wherein the tool is configured such that the axial drive limiting member contacts the housing and limits axial travel of the drive shaft relative to the housing.

2. A tool as recited in claim 1, wherein the feet are adjustable relative to the housing.

3. A tool as recited in claim 1, wherein the axial drive limiting member comprises a split ring which is engaged with an externally threaded surface of the drive shaft.

4. A tool as recited in claim 1, further comprising a drive adapter which is engaged with an end of the drive shaft and is configured for engagement with the drill.

5. A tool as recited in claim 1, further comprising a guide tube, and a drive socket which is engaged with an end of the drive shaft and is configured to retain the guide tube and engage the fastener.

6. A tool as recited in claim 5, wherein the drive socket is configured to engage an end of the guide tube in a press fit arrangement, and an opposite end of the guide tube has a fastener retainer thereon for holding a fastener in the drive socket.

7. A tool as recited in claim 1, further comprising a washer which is disposed in the housing, wherein the spring is disposed between an internal wall of the housing and the washer.

8. A tool as recited in claim 7, further comprising a thrust bearing which is disposed between the drive socket and the washer.

9. A tool as recited in claim 1, wherein the drive shaft is exposed in an area between the drill and the axial drive limiting member.

10. A tool for operation with a drill for installing a fastener, said tool having a first end configured to engage with the drill and a second end configured to engage the fastener, said tool comprising: a housing; a spring in the housing; a drive shaft which is exposed and extends into the housing, through the spring, and is configured to rotate upon operation of the drill; and an axial drive limiting member on the drive shaft and contactable with the housing, wherein the tool is configured such that the axial drive limiting member contacts the housing and limits axial travel of the drive shaft relative to the housing.

11. A tool as recited in claim 10, further comprising feet which are engaged with the housing such that stepping on the feet during use of the tool causes the spring in the housing to compress.

12. A tool as recited in claim 11, wherein the feet are adjustable relative to the housing.

13. A tool as recited in claim 10, wherein the axial drive limiting member comprises a split ring which is engaged with an externally threaded surface of the drive shaft.

14. A tool as recited in claim 10, further comprising a drive adapter which is engaged with an end of the drive shaft and is configured for engagement with the drill.

15. A tool as recited in claim 10, further comprising a guide tube, and a drive socket which is engaged with an end of the drive shaft and is configured to retain the guide tube and engage the fastener.

16. A tool as recited in claim 15, wherein the drive socket is configured to engage an end of the guide tube in a press fit arrangement, and an opposite end of the guide tube has a fastener retainer thereon for holding a fastener in the drive socket.

17. A tool as recited in claim 10, further comprising a washer which is disposed in the housing, wherein the spring is disposed between an internal wall of the housing and the washer.

18. A tool as recited in claim 17, further comprising a thrust bearing which is disposed between the drive socket and the washer.

19. A tool for operation with a drill for installing a fastener, said tool having a first end configured to engage with the drill and a second end configured to engage the fastener, said tool comprising: a housing; a spring in the housing, a drive shaft which extends into the housing, through the spring, and is configured to rotate upon operation of the drill; a split ring on the drive shaft and contactable with the housing; feet which are engaged with the housing and adjustable relative thereto, wherein the tool is configured such that stepping on the feet during use of the tool causes the spring in the housing to compress, wherein the tool is configured such that the axial drive limiting member contacts the housing and limits axial travel of the drive shaft relative to the housing; a drive adapter which is engaged with an end of the drive shaft and is configured for engagement with the drill; a guide tube, and a drive socket which is engaged with an end of the drive shaft and is configured to retain the guide tube and engage the fastener, wherein the drive socket is configured to engage an end of the guide tube in a press fit arrangement, and an opposite end of the guide tube has a fastener retainer thereon for holding the fastener in the drive socket; a washer which is disposed in the housing, wherein the spring is disposed between an internal wall of the housing and the washer; a thrust bearing which is disposed between the drive socket and the washer, wherein the drive shaft is exposed in an area between the drill and the axial drive limiting member.
